(19) United States
(12) Patent Application Publication
(10) Pub. No.: US 2002/0128944 A1
(43) Pub. Date: Sep. 12, 2002

(54) Public hub employing a trusted agent to facilitate the exchange of commodities

(75) Inventors: Michael Ray Crabtree, Singapore (SG); Suhwe Lee, Singapore (SG); Nancy Quek, Singapore (SG)

Correspondence Address: Blanche E. Schiller, Esq., HESLIN & ROTHENBERG, P.C., 5 Columbia Circle, Albany, NY, 12203, US

(73) Assignee: International Business Machines Corporation, Armonk, NY (US)

(21) Appl. No.: 09/752,204

(22) Filed: Dec. 29, 2000

(51) Int. Cl. G06F 17/60

(52) U.S. Cl. 705/37

(57) ABSTRACT

A public hub and trusted agent cooperate to facilitate the exchange of commodities. The trusted agent is responsible for controlling various aspects of the exchange. For instance, the trusted agent administers selected critical aspects of the process, while not getting involved in other non-critical activities. The trusted agent shields other participants involved with the exchange from selected information, thus protecting sensitive information, business processes and relationships from those participants.

### CROSS-REFERENCE TO RELATED APPLICATIONS

This application contains subject matter which is related to the subject matter of the following application, which is assigned to the same assignee as this application. The below listed application is hereby incorporated herein by reference in its entirety:

“Network-Based Virtual Commodity Exchange”, Crabtree et al., (IBM Docket No. JP919990707), U.S. Ser. No. 09/544,026, filed on Apr. 6, 2000.

### TECHNICAL FIELD

This invention relates, in general, to the exchange of commodities, and in particular, to creating private trading relationships within a public trading hub used to exchange commodities.

### BACKGROUND ART

In a commodity exchange environment, there are various methodologies used in the exchange of commodities including, for instance, a fully integrated fulfillment model and a distributed fulfillment model, each of which is described herein. In a fully integrated fulfillment model, an example of which is depicted in FIG. 1a, the Original Equipment Manufacturer (OEM) has complete visibility to the supply chain, allowing for direct control over all supply chain issues, such as, critical parts management, pricing, up-side flexibility, and critical path analysis. However, with the growth of specialization and globalization, cost and flexibility issues prohibit the OEM from utilizing a fully integrated fulfillment model.

Thus, OEMs rely on distributed fulfillment models that utilize contract manufacturers for many major subassemblies. One example of a distributed fulfillment model is depicted in FIG. 1b. While improving cost and flexibility, the distributed fulfillment model means that the contract manufacturers have much more control of the down-stream supply chain. This creates many new challenges for the OEM including complicated and redundant communications paths throughout the supply chain; an inability to aggregate the usage of common components across the contract manufacturers; an inability to influence the actions of critical suppliers buried in lower levels of the supply chain; and difficulty in identifying, managing, and leveraging strategic components and commodities in the supply chain. That is, without direct control of the strategic commodities, it is extremely difficult for the OEM to properly control the product cost or ensure continuity of supply.

In order to improve communication across the layers of the supply chain, a public trading exchange (trading hub) has been introduced into the model. One example of using a hub is depicted in FIG. 2, and described in a co-pending U.S. Patent Application, entitled “Network-Based Virtual Commodity Exchange”, Crabtree et al., (IBM Docket No. JP919990707), U.S. Ser. No. 09/544,026, filed on Apr. 6, 2000, which is hereby incorporated herein by reference in its entirety. (The discussion of this reference in this section is not an admission that it is prior art.)

Although the use of a public hub has improved communication, since by its very nature a public hub is an open environment (a level playing field), it provides no defined hierarchical authority for control decisions. These open channels of communication without clear lines of authority create a whole new set of issues for the OEM. For example, proprietary information (e.g., pricing, contract terms, strategic relationships, product schedules) are difficult to protect. Also, relationships can easily form among subsets of the supply chain players that sub-optimize the ultimate goals of the OEM.

Thus, a need still exists for an adequate commodities exchange structure that improves communication and protects proprietary information and strategic relationships. In particular, a need exists for a public hub structure that includes a hierarchical authority to protect and control key business processes.

### SUMMARY OF THE INVENTION

The shortcomings of the prior art are overcome and additional advantages are provided through the provision of a method of facilitating the exchange of commodities. The method includes, for instance, utilizing a public hub in the exchange of one or more commodities, wherein a plurality of entities is associated with the exchange; and performing one or more selected functions of the exchange via an automated trusted agent.

In one embodiment, the trusted agent is responsible for protecting (e.g., shielding) selected business information from other participants of the exchange. This information includes, for instance, price and contract terms, strategic relationships, business processes, and/or product schedules.

In a further aspect of the invention, a method of facilitating the exchange of commodities is provided. The method includes, for instance, requesting by a first entity to obtain one or more commodities of a product, the one or more commodities to be obtained from one or more second entities via a public hub; and using an automated trusted agent to interface between the first entity and the one or more second entities, wherein one or more aspects associated with obtaining the one or more commodities are controlled by the trusted agent.

Advantageously, the trusted agent provides for an entity, such as the OEM, protection of strategic competitive advantage, administration of critical processes across the exchange, and visibility to important business communication and performance metrics across the various parts of the extended supply chain. The trusted agent adds a hierarchical authority to a public hub structure.

System and computer program products corresponding to the above-summarized methods are also described and claimed herein.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1a depicts one example of a fully integrated fulfillment model used in the exchange of commodities;

FIG. 1b depicts one example of a distributed fulfillment model used in the exchange of commodities;

FIG. 2 depicts one example of a public hub utilized in the distributed fulfillment model of FIG. 1b;

FIG. 3 depicts one example of a trusted agent used to create a hierarchical authority for a public hub structure, in accordance with an aspect of the present invention;

FIGS. 4a-4b depict one embodiment of various components of a trusted agent, in accordance with an aspect of the present invention;

FIG. 5 depicts one embodiment of various tools used by the trusted agent of FIG. 3, in accordance with an aspect of the present invention;

FIGS. 6a-6c depict one embodiment of the logic associated with a buy/sell process that uses a trusted agent, in accordance with an aspect of the present invention; and

FIG. 7 is a pictorial depiction of the buy/sell process described with reference to FIGS. 6a-6c, in accordance with an aspect of the present invention.

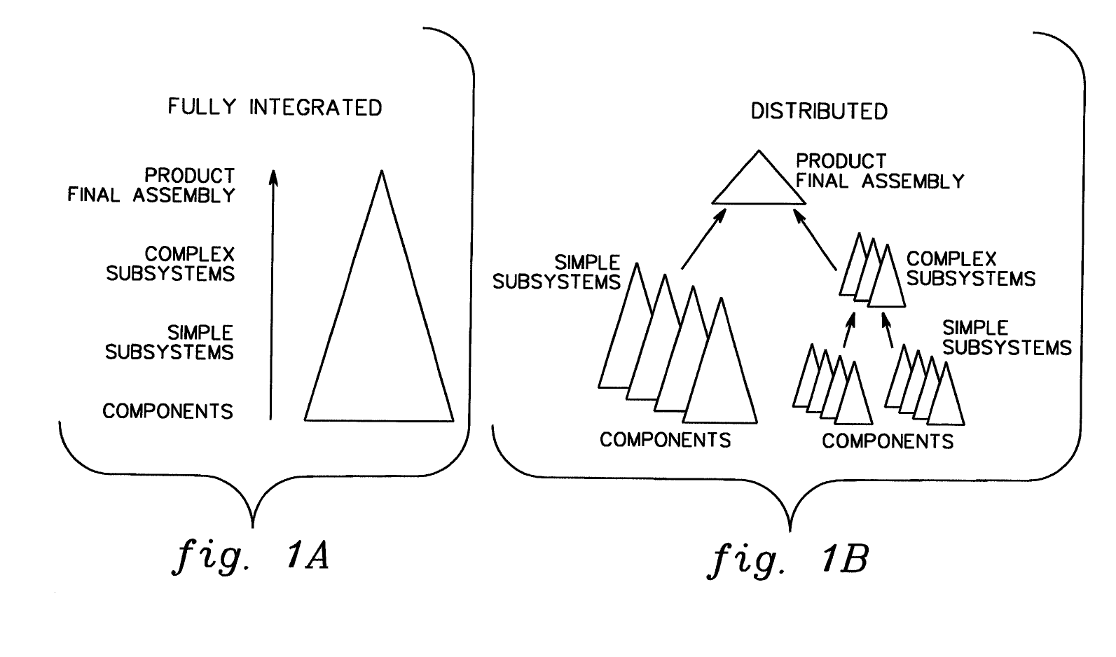

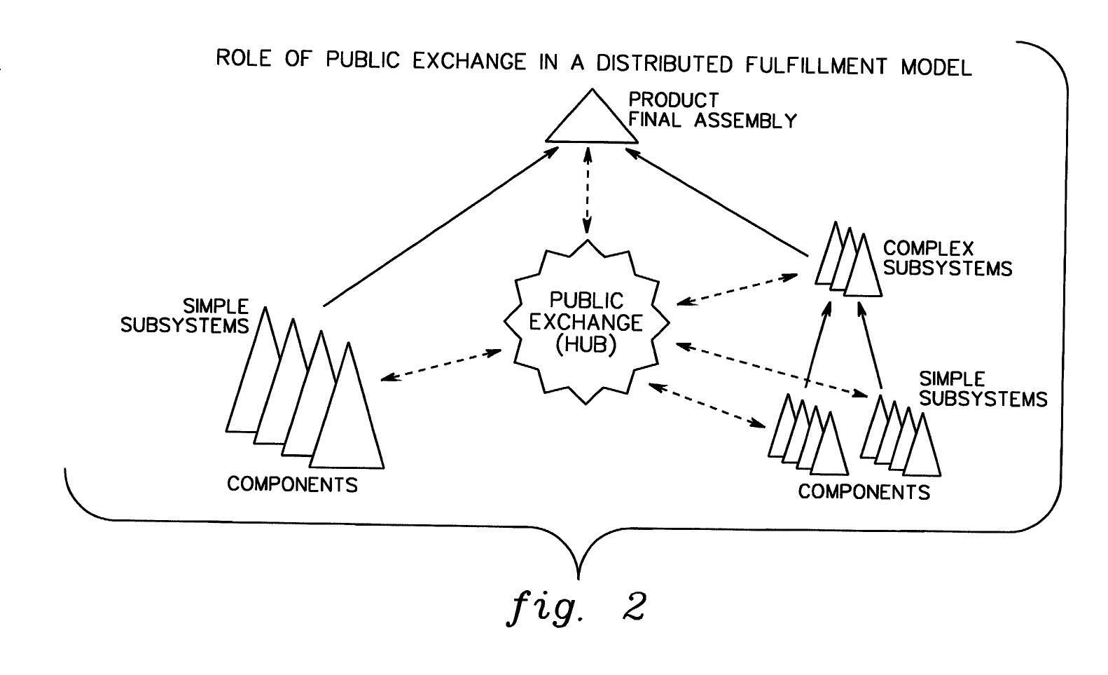

### BEST MODE FOR CARRYING OUT THE INVENTION

In accordance with an aspect of the present invention, a trusted agent is used with a public hub structure to facilitate the exchange of commodities, e.g., over a network. The trusted agent provides hierarchical authority for key business processes. In particular, through a set of electronic tools, the trusted agent is able to act on behalf of an entity, such as an Original Equipment Manufacturer (OEM), to administer, for instance, selected mission critical aspects of the fulfillment process, and at the same time, to continue to allow direct interaction between entities of the process for non-critical activities.

The trusted agent can be employed in a variety of commodity exchange relationships, including a buy/sell relationship, which is the model described in the examples herein. Although a buy/sell model is described in the examples, the invention is not limited to such a model.

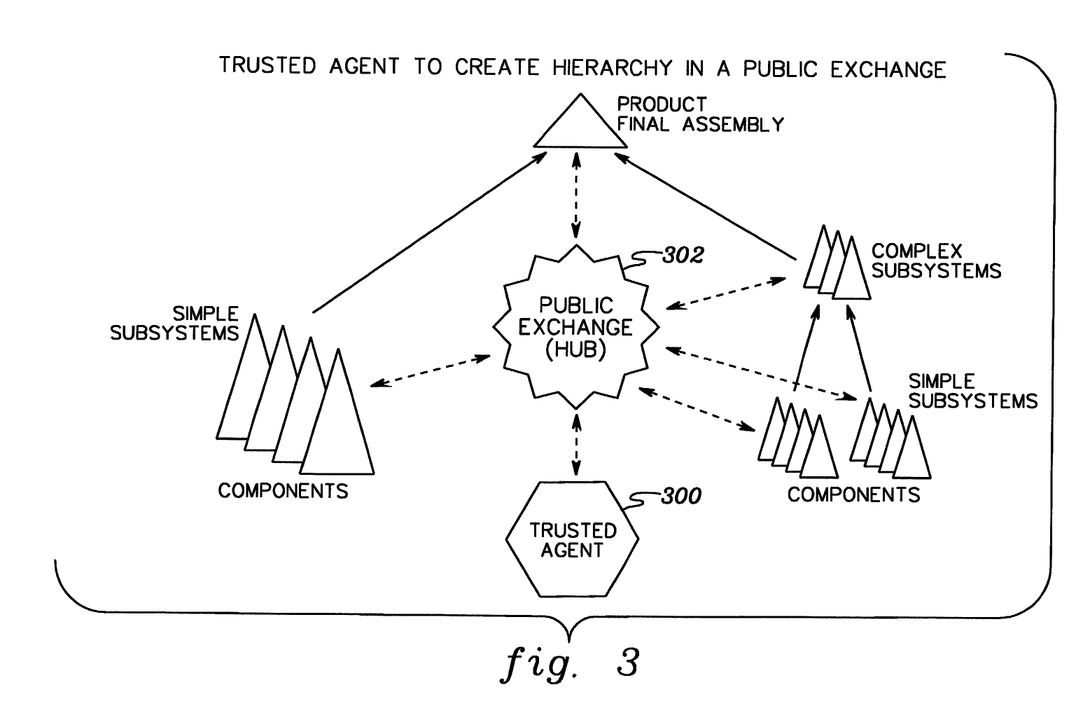

One example of a trusted agent is depicted in FIG. 3. As shown, a trusted agent 300 is associated with a public hub 302, both of which cooperate to facilitate the exchange of commodities over, for instance, a network, such as an Internet, Intranet, Extranet or other type of network. As examples, the trusted agent is coupled to or a part of the public hub. That is, the functions of the trusted agent can be provided by the same business entity that provides the public hub functions or the trusted agent functions can be provided by an independent entity. In either case, the trusted agent functions are to be performed by an entity trusted by all the parties involved in a transaction.

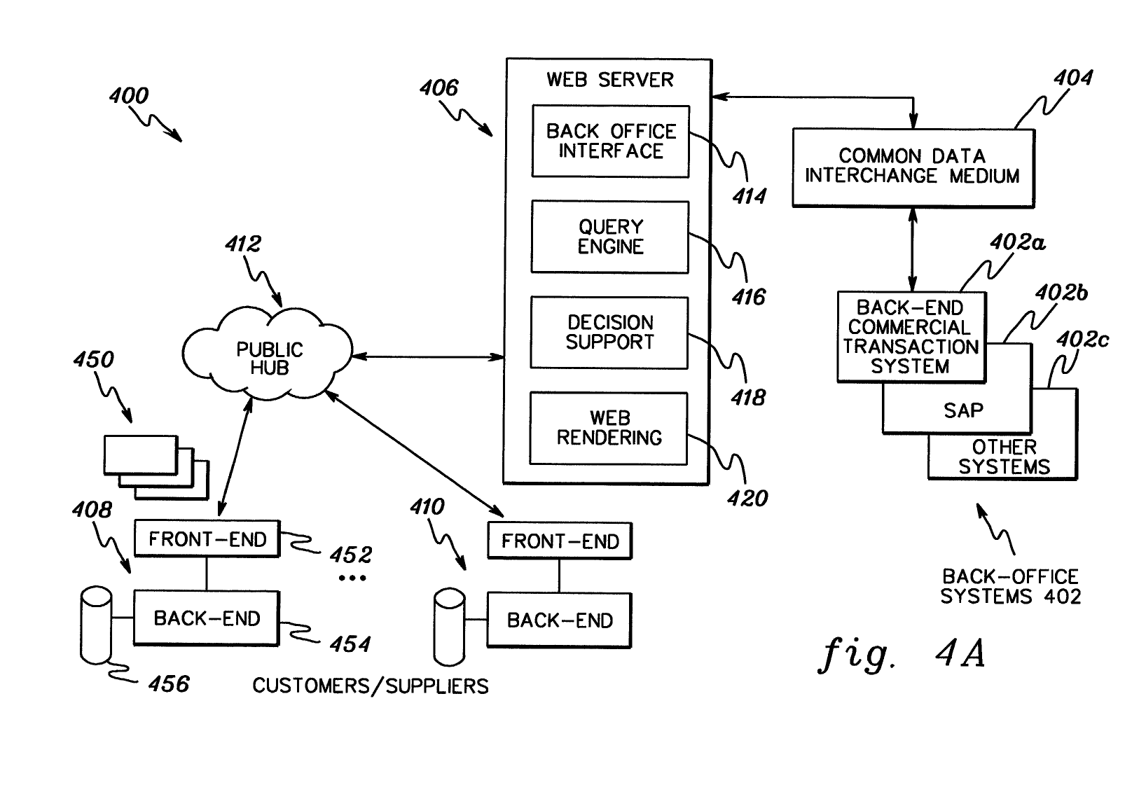

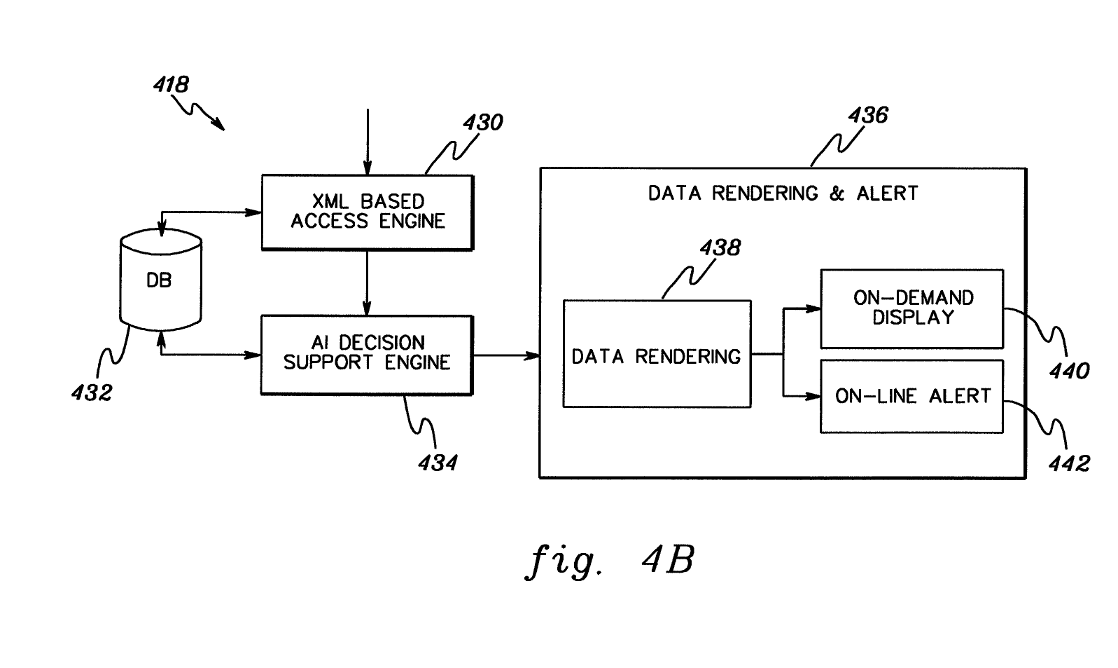

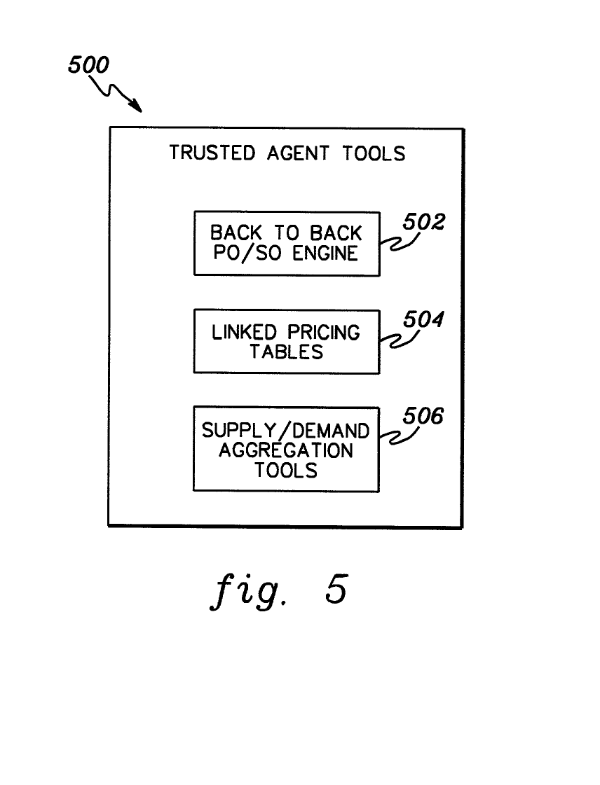

One embodiment of various elements of a trusted agent are described with reference to FIGS. 4a-4b and FIG. 5. With reference to FIG. 4a, the trusted agent includes, for instance, one or more back-office transaction processing systems 402, a data interchange medium 404, and a web application server (or web server) 406. The trusted agent is coupled to customer systems 408 and/or supplier systems 410 via a public hub 412. The public hub (or trading hub) is the medium through which the supplier, customer, and trusted agent are connected. Each of the above components is described in further detail below.

The overall system architecture of the trusted agent allows essentially any back-office transaction processing system 402 to be utilized. As examples, the back-office transaction processing system can be a back-end commercial transaction system 402a, an SAP (Systems, Applications and Products in data processing) system 402b, and/or another legacy system 402c. A SAP is, for instance, an integrated software application that has a set of business application software modules for many large business functions including manufacturing, sales and distribution, human resources, and finance. SAP can be implemented using main frame and/or client/server technology, as examples. In one example, the back office transaction processing system handles back-to-back purchase orders/sales orders.

Data interchange medium 404 is a common data interchange medium shown schematically between web server 406 and back-office transaction processing systems 402. It enables electronic transmission of business transactions between the various entities of an exchange (such as a contract manufacturer, a supplier, a trusted agent and an OEM). Data interchange medium 404 may be implemented using, for example, XML or XML with compliance to the existing standardized electronic data interchange (EDI) format. Utilization of XML data exchange constructs allows information from web server 406 to be mapped and transmitted seamlessly to back-office systems 402. The data interchange medium creates a gateway into the back-office through a standardized interface. This element may not be needed when all entities understand the same format (e.g., XML) for data interchange.

Web server 406 is the command center of the trusted agent, and is connected to public hub 412 via a network such as the Internet, Intranet, Extranet, or other type of network. The public hub provides user registration and authentication functions common to all hub users. One example of a public hub is described in the aforementioned U.S. Patent Application, entitled “Network-Based Virtual Commodity Exchange”, Crabtree et al., (IBM Docket No. JP919990707), U.S. Ser. No. 09/544,026, filed on Apr. 6, 2000, which is hereby incorporated herein by reference in its entirety.

In one embodiment, web server 406 of the trusted agent includes the following functional modules: a back office interface module 414, a query engine module 416, a decision support module 418, and a web-rendering module 420, each of which is described below.

Back office interface 414 is implemented, for instance, using XML over the Internet, Intranet, Extranet, or other network to communicate with back office systems 402.

Query engine 416 accepts web-based information queries and maps the queries (via, for instance, XML) into a command structure recognized by the back office systems. To follow up on on-going activities during exchanges, both buyers and sellers can make XML queries to the database of web server 406 for status tracking and updates. The XML query can preferably issue automatically from a customer's system without human intervention. Further, web server 406 allows customers to raise a request for information (RFI) and a request for quote (RFQ) to query the database. All such requests can be automatically processed through XML queries between systems 408, 410 of customers and suppliers by server-to-server data interchange.

Decision support module 418 includes, for instance, an XML-based web access engine 430 (FIG. 4b), a database 432, an Artificial Intelligence (AI) based decision support engine 434, and a data rendering and alert tool 436. The data rendering and alert tool includes, for instance, a data rendering module 438, an on-demand display module 440, and an on-line alert module 442.

XML-based access engine 430 receives input from network locations and provides output to AI decision support engine 434. Both the XML-based access engine and the AI decision support engine are coupled to database 432, so that data can be read from and written to the database. AI decision support engine 434 is coupled to data rendering and alert module 436. For example, data rendering module 438 of data rendering and alert module 436 receives input from the AI decision support engine. In turn, data rendering module 438 provides output to both on-demand display module 440 and on-line alert module 442.

XML-based access engine 430 pulls information from public and proprietary sources that support the XML data interchange format and stores the information in database 432. As one example, database 432 is a historical commodity database serving as a repository of relevant information pertaining to one or more particular commodities populated by, for example, three main sources: information dynamically pulled from the web utilizing XML, proprietary information collected by internal commodity experts via traditional intelligence gathering techniques, and by automatic, historical analysis of previous predictions against actual historical events. This functionality is implemented, in one example, using Java applets that pull information from information sources provided via, for instance, the Internet, Intranet, Extranet, or other network.

AI based decision support engine 434 is based on the decision processes used by existing content experts (i.e., professional buyers for each commodity with the highest successful purchasing record) to extract important trends and events from the data repository (i.e., database 432). As one example, the AI based decision support engine is an expert decision support matrix built utilizing conventional AI methods well known to those skilled in the art. The engine is built based on a combination of traditional commodity trading techniques and extensive analysis of the decision processes used by existing content experts. Entries in the historical commodity database are time stamped. Testing historical predictions against historical events can be used to validate the accuracy of the AI decision support matrix.

Data rendering and alert tool 436 tabulates and displays important trend and other decision results in a graphical format on-line or on demand. The data rendering and alert tool forms part of the decision support (e.g., software) module and is a data rendering tool for extracting, formatting, and presenting real-time information to commodity traders. Based on AI decision support engine 434, data rendering and alert module 436 provides prompts to the commodity traders. Such prompts include, for instance: (1) highlighting the current key indicators to watch; (2) recommending specific actions when a buy/sell transaction is to be performed; and (3) triggering alerts to a buyer's desktop when predetermined trigger conditions occur.

Returning to FIG. 4a, web server 406 also includes web rendering component 420. The web rendering component provides various functions including, for instance, using the XML data interchange constructs to pass formatted information directly between back-office systems 402 and the back-office systems of customers and/or suppliers 408, 410; and rendering, in HTML format, information screens and forms, so that users can rely on a traditional web interface (i.e., locate an http web page and fill in the blanks or review information screens).

Customers 408 and/or suppliers 410 can access systems 402, 404, 406 (i.e., the trusted agent) through a traditional web browser via public hub 412. Alternatively, the access may be through server-to-server data interchange using the XML standard. It is not necessary for customers 408 and/or suppliers 410 to have the same architecture as systems 402, 404, 406 to access those systems. Rather, the customer/supplier can either upload and/or download information through a web browser, as long as the computer system(s) of the customer/supplier understands the same language (e.g., XML). Alternatively, the customer/supplier computer system can perform server-to-server level communication to interchange data. Information 450 can be passed between customer/supplier systems 408, 410 and systems 402, 404, 406 via public hub 412.

In one embodiment, customer system 408 includes a front-end processing system 452, a backend processing system 454, and a storage media 456 for storing data. Likewise, supplier system 410 has a corresponding structure or arrangement. When a supplier and/or customer front-end 452 connects to public hub 412 via a standard language (e.g., XML), complete end-to-end communications through both organizations purchasing systems is enabled.

Front-end processing systems 452 typically include a web server to provide the store front portion of e-commerce or e-business systems, including electronic catalogs, shopping carts, user profiles, and other items that assist with purchasing. Back-end system 454 involves functionality including order entering, the creation of purchase orders, payment processing and the like. For example, the back-end system may be connected to a bank and/or other payment institution for payment of user purchases. However, for business-to-business purchases, a 30-day account payment system may be used. Numerous payment schemes can be practiced without departing from the scope and spirit of the invention. In many existing systems, the front-end and back-end systems require proprietary or batch software to integrate the two.

As described herein, the trusted agent is used with the public hub in order to create a hierarchical authority for key business processes. In one example, the trusted agent is automated, and includes one or more tools to assist the agent in performing its tasks. One embodiment of these tools is depicted in FIG. 5 and described herein. In one example, the trusted agent includes, a back-to-back PO/SO engine 502; linked pricing tables 504; and supply/demand aggregation tools 506.

Back-to-back PO/SO engine 502 is, for example, a special configuration of a purchasing system that maintains relationships between the associated sales order and purchase order, links the commit processes, and controls the purchase order/supply order invoice and payment processes. In particular, PO/SO engine 502 handles the mechanics of receiving and confirming an SO, sending and confirming a PO, invoicing and billing.

Engine 502 (which, in one example, is implemented through a configuration of SAP) gives the trusted agent tight control of the order process without inserting delays in the purchasing process. This system includes standard business and financial control points, logging, and exception reporting procedures. One example of such an engine is described with reference to FIG. 4a (see, e.g., back-office systems 402).

The linked pricing tables include linked SO/FO pricing structures for each component or commodity being exchanged. In particular, for strategic commodities being supplied to a contract manufacturer for a buy/sell model, the trusted agent has exclusive access to two price tables: (a) a buy price table, which includes the preferential price negotiated by the OEM with the component supplier; and (b) a sell price table, which includes the industry average price for the sale of the component to the contract manufacturer. Automatic price update features allow the OEM to dynamically control the SO and PO prices.

The supply/demand aggregation tools allow the trusted agent to quickly summarize and analyze historic supply/demand information and supply/demand forecasts. In one example, the supply/demand aggregation function is implemented in decision support module 418 (FIGS. 4a and 4b). For example, supply/demand information is loaded into DB 432 (see FIG. 4b) via XML access engine 430. The information is analyzed via AI decision support engine 434, formatted by data rendering tool 438, and disseminated on demand 440 or via alert 442 through the public hub (412 in FIG. 4a).

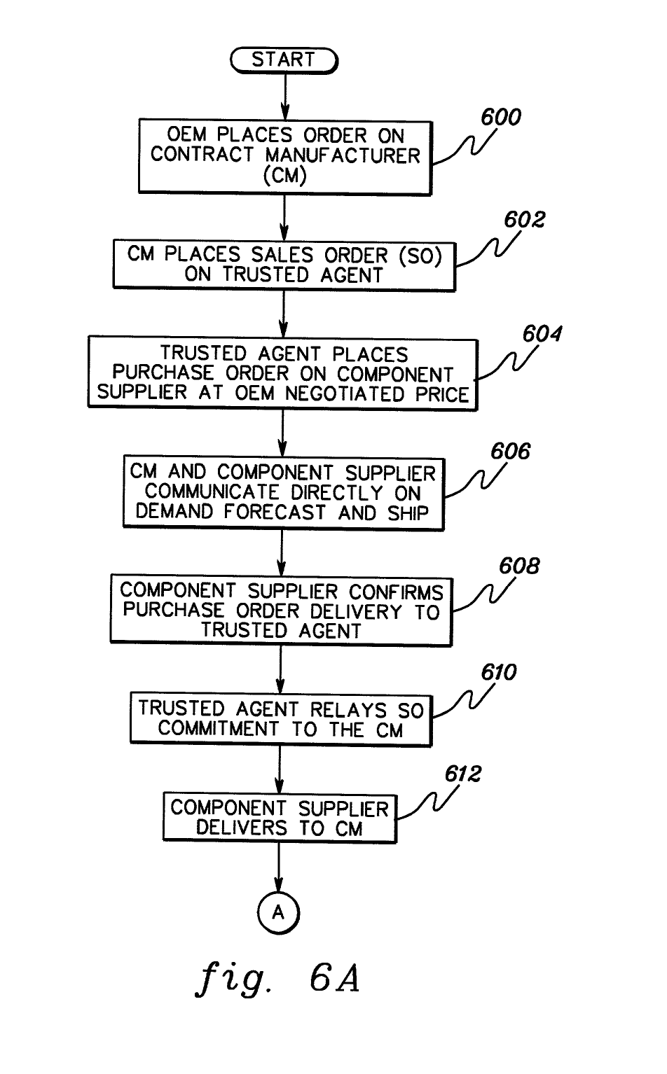

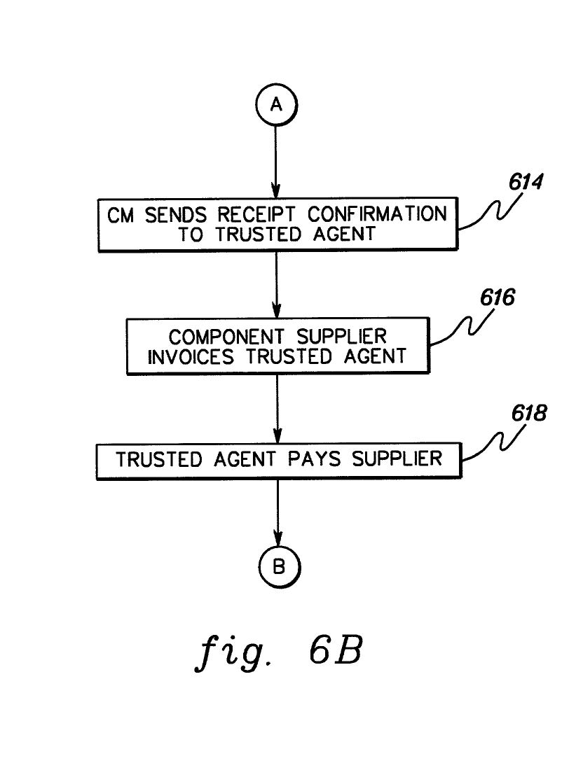

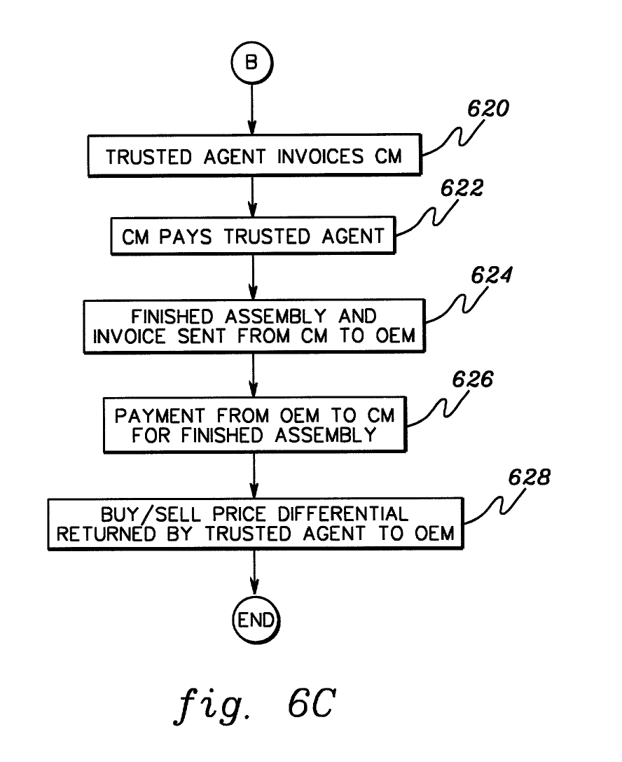

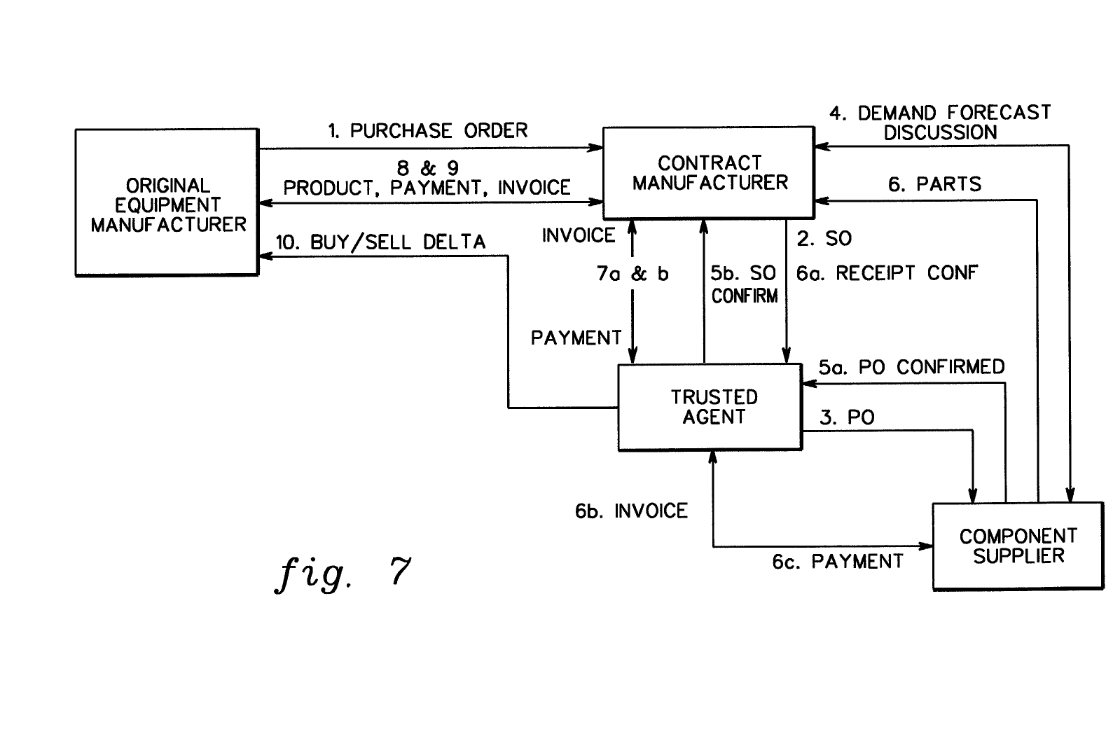

One embodiment of a process flow for utilizing a trusted agent in a commodity exchange (e.g., a buy/sell exchange) is described with reference to the logic flow of FIGS. 6a-6c and the pictorial depiction of FIG. 7. In accordance with an aspect of the present invention, trading functions that involve critical information are consolidated into the trusted agent. The trusted agent communicates with the other entities of the exchange (e.g., the contract manufacturer, supplier and customer) via the public hub.

Referring to FIG. 6a, initially, an entity, such as an Original Equipment Manufacturer (OEM) places an order at another entity, such as a contract manufacturer (CM), STEP 600. The contract manufacturer then places one or more sales order(s) at the trusted agent (TA), STEP 602.

The sales order, which is the responsibility of the trusted agent, is converted by the trusted agent to a purchase order for one or more suppliers. The purchase order includes the OEM negotiated price (i.e., the buy price), and is forwarded, by the trusted agent, to one or more component suppliers (CS), STEP 604.

The contract manufacturer and component supplier(s) then communicate directly on demand forecast and ship details, STEP 606. The trusted agent is not involved in these discussions, in one example. In due course, the component supplier confirms the purchase order delivery to the trusted agent, STEP 608, and the trusted agent relays the sales order commitment to the contract manufacturer, STEP 610.

Thereafter, the component supplier delivers the components to the contract manufacturer, STEP 612. In response to the delivery, the contract manufacturer sends a delivery confirmation to the trusted agent, STEP 614 (FIG. 6b); the component supplier invoices the trusted agent, STEP 616; and the trusted agent pays the component supplier at the buy price, STEP 618.

Thereafter, the trusted agent invoices the contract manufacturer, STEP 620 (FIG. 6c) at, for instance, a sell price (i.e., the industry average price for the sale of the component to the contract manufacturer), and the contract manufacturer then pays the trusted agent the sell price, STEP 622.

Subsequently, the finished assembly and invoice are sent from the contract manufacturer to the OEM, STEP 624, and the OEM pays the contract manufacturer for the finished assembly, STEP 626. Additionally, any buy/sell price differential is returned by the trusted agent to the OEM, STEP 628.

As described above, in accordance with an aspect of the present invention, the trusted agent is utilized within a public hub environment to control various elements of a business process. In one example, this business process is a commodity exchange employing a buy/sell model. In the buy/sell model described herein, the trusted agent purchases components at negotiated contracts (the buy price), and then sells the components to a contract manufacturer at an up-lifted market price (the sell price). Thereafter, the trusted agent rebates the difference, if any, between the buy price and the sell price to the OEM.

Although the example described herein employs the trusted agent in a buy/sell relationship, the invention is not limited to such a relationship or model. The invention applies to any situation where confidential or private information is to be shared among multiple parties within the constructs of a public trading exchange.

As described herein, the trusted agent is employed by a public hub to control critical decision points. For instance, the trusted agent controls supply chain discussions between the contract manufacturer and the supplier in a buy/sell relationship. Examples of the various elements controlled by the trusted agent include:

(1) Price Tables: For strategic commodities being supplied to the contract manufacturer, the trusted agent has exclusive access to two price tables:

(a) a buy price table, which is the preferential price negotiated by the OEM with the component supplier; and

(b) a sell price table, which is the industry average price for the sale of the component to the contract manufacturer. This allows the trusted agent to protect the OEM's strategic pricing and strategic contract terms from other participants in the public hub. That is, this information is masked or shielded from the participants of an exchange (e.g., the contract manufacturer(s) and/or component supplier(s)).

(2) Purchase Order/Supply Order Commitment: Sales orders and sale order commitments are the responsibility of the trusted agent. Each contract manufacturer's sales order is converted to a purchase order for the appropriate supplier. Formal confirmation of delivery commitments from the supplier (PO confirmation) are transmitted through the trusted agent to the contract manufacturer (SO confirmation).

Through this mechanism, the trusted agent can control the allocation of constrained parts across multiple contract manufacturers, and can perform order splits (divide a single SO into POs to multiple suppliers).

(3) Demand Aggregation: The trusted agent is the only party, in this example, that has a complete view of aggregate supply and demand across the contract manufacturers and suppliers for the parts being exchanged. This is critical information for the OEM to ensure that purchasing volume commitments made to a supplier are honored and that supply/demand mismatches are recognized early.

Thus, by employing the trusted agent, the OEM is able to utilize the public hub without losing control of critical information, business processes, and relationships. The desired information, processes and relationships are shielded from and transparent to various of the entities of the exchange (e.g., the contract manufacturers, suppliers). The OEM is able to use the public hub (facilitated by the trusted agent) to construct a business process that offers the best characteristics of the different fulfillment models, as depicted in the table below.

| | | | Distributed |
|---|---|---|---|
| | | Distributed | Fulfillment w/ |
| | | Fulfillment w/ | Exchange-based |
| | Distributed Fulfillment w/ | Exchange-based | thru Trusted |
| Integrated Fulfillment | Hierarchical Comm | Comm | Agent |
| OEM's | competitive | competitive | OEM's |
| competitive | advantage shared | advantage shared | competitive |
| advantage is | between OEM and | between OEM and | advantage is |
| protected | CM | CM | protected |
| OEM has direct | CM has | CM has | OEM has direct |
| relationships | relationships | relationships | relationships |
| with strategic | with strategic | with strategic | with strategic |
| parts providers | parts providers | parts providers | parts providers |
| OEM price | limited price | limited price | OEM price |
| protection for | protection | protection | protection for |
| strategic parts | | | strategic parts |
| OEM controls | CM controls | CM controls | OEM controls |
| critical | critical | critical | critical |
| processes | processes | processes | processes |
| OEM aggregates | CMs control | CMs control | OEM aggregates |
| strategic parts | strategic parts | strategic parts | strategic parts |
| supply/demand | supply/demand | supply/demand | supply/demand |
| | independently | independently | |
| lack of | highly | highly | highly |
| flexibility in | flexibility in | flexibility in | flexibility in |
| fulfillment | fulfillment | fulfillment | fulfillment |
| process | process | process | process |
| high OEM | low OEM | low OEM | low OEM |
| manufacturing | manufacturing | manufacturing | manufacturing |
| investments | investments | investments | investments |
| ability to | unable to | unable to | ability to |
| control | control | control | control |
| allocation of | allocation of | allocation of | allocation of |
| constrained | constrained | constrained | constrained |
| parts across | parts across | parts across | parts across |
| complete product | multiple CMs | multiple CMs | complete |
| set | | | product set |
| clear | unclear | clear | clear |
| communication | communication | communication | communication |
| paths | paths | paths | paths |

Advantageously, the trusted agent enables the use of a public hub by controlling sensitive information and relationships. Private relationships (such as buy/sell relationships) are created within the public hub.

As described above, although a buy/sell relationship is described herein, this is only one example. Other types of relationships may also benefit from the use of a trusted agent. Further, the invention may be used with the exchange of any types of commodities or components. Examples of commodities are manufactured components, electronic components, raw materials, hand-crafted components, etc. Any commodity that can be exchanged (including a service) is included within the scope of the invention. The above is only illustrative.

The various functions described herein can be implemented in hardware, software or a combination thereof. Further, they may be implemented using discrete electronic components, or one or more of them could form a portion of an entire electronic circuit, such as an application specific integrated circuit (ASIC).

Numerous configurations of computer systems can be employed for aspects of the present invention. Computers with which the embodiment can be practiced include IBM-PC/ATs or compatibles, the MacIntosh™ family of PCs, Sun Sparcstation™, a workstation, or the like. The foregoing are merely examples of types of computers with which the embodiments of the invention may be practiced.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating the exchange of commodities, said method comprising:
utilizing a public hub in the exchange of one or more commodities, wherein a plurality of entities is associated with the exchange; and
performing one or more selected functions of the exchange via an automated trusted agent.

2. The method of claim 1, wherein the one or more selected functions of the exchange include managing one or more pricing terms associated with the exchange.

3. The method of claim 2, wherein the managing of one or more pricing terms includes masking at least one pricing term of the one or more pricing terms to shield the at least one pricing term from one or more entities of the plurality of entities.

4. The method of claim 3, wherein the one or more entities include one or more contract manufacturers.

5. The method of claim 3, wherein the one or more entities include one or more suppliers.

6. The method of claim 1, wherein the one or more selected functions of the exchange include managing one or more contract terms associated with the exchange.

7. The method of claim 1, wherein the performing enables protection of one or more contract terms associated with the exchange from one or more entities of the plurality of entities.

8. The method of claim 7, wherein the protection includes shielding price from one or more entities of the plurality of entities.

9. The method of claim 1, wherein at least one entity of said plurality of entities includes at least one contract manufacturer, and wherein the performing enables controlling allocation of commodities across the at least one contract manufacturer.

10. The method of claim 1, wherein multiple entities of said plurality of entities include multiple suppliers, and wherein the performing enables dividing an order for a plurality of commodities of the exchange among the multiple suppliers.

11. The method of claim 1, wherein the performing enables the managing of supply and demand of commodities.

12. The method of claim 1, wherein the automated trusted agent includes one or more tools utilized in performing the one or more selected functions.

13. The method of claim 12, wherein the one or more tools include at least one of a purchase order/supply order engine, linked pricing tables, and one or more supply/demand aggregation tools.

14. The method of claim 1, wherein the automated trusted agent is coupled to the public hub.

15. The method of claim 1, wherein the automated trusted agent is a part of the public hub.

16. The method of claim 1, wherein the exchange is based on a buy/sell model.

17. The method of claim 1, wherein one entity of the plurality of entities is an Original Equipment Manufacturer (OEM), and wherein said utilizing the public hub comprises utilizing the public hub by the OEM to obtain a product having at least a portion of the one or more commodities.

18. The method of claim 17, wherein the automated trusted agent enables the OEM to retain control of one or more facets of the exchange.

19. The method of claim 18, wherein the automated trusted agent enables the OEM to retain control of at least one of sensitive information, one or more business processes, and one or more relationships associated with the exchange.

20. The method of claim 1, wherein said utilizing the public hub comprises utilizing the public hub in a networked environment.

21. The method of claim 1, wherein the plurality of entities comprises one or more contract manufacturers and one or more suppliers.

22. The method of claim 21, wherein the performing one or more selected functions of the exchange via the automated trusted agent comprises:
placing an order for the one or more commodities with at least one supplier of the one or more suppliers, the order representing a request from at least one contract manufacturer of the one or more contract manufacturers;
handling one or more invoices received from the at least one supplier; and
invoicing the at least one contract manufacturer requesting the one or more commodities.

23. The method of claim 22, wherein the plurality of entities further comprises an Original Equipment Manufacturer (OEM) requesting one or more products from the one or more contract manufacturers, and wherein the performing further comprises forwarding to the OEM a price differential, if any, resulting from a difference in the one or more invoices received from the at least one supplier and the invoicing of the at least one contract manufacturer.

24. A method of facilitating the exchange of commodities, said method comprising:
requesting by a first entity to obtain one or more commodities of a product, said one or more commodities to be obtained from one or more second entities via a public hub; and
using an automated trusted agent to interface between said first entity and said one or more second entities, wherein one or more aspects associated with obtaining said one or more commodities are controlled by said automated trusted agent.

25. The method of claim 24, wherein the one or more aspects include invoicing associated with the one or more commodities.

26. The method of claim 24, wherein the first entity is a contract manufacturer and the one or more second entities are one or more suppliers.

27. The method of claim 24, further comprising placing an order for the product at said first entity, by a third entity.

28. The method of claim 27, wherein said third entity is an Original Equipment Manufacturer (OEM), and wherein the automated trusted agent protects for the OEM one or more facets associated with the order.

29. The method of claim 28, wherein the one or more facets include one or more contract terms.

30. The method of claim 29, wherein the one or more contract terms include one or more price terms.

31. The method of claim 28, wherein the one or more facets include at least one of sensitive information, one or more business processes, and one or more relationships associated with obtaining the one or more commodities.

32. The method of claim 24, wherein the automated trusted agent is a part of the public hub.

33. The method of claim 24, wherein the automated trusted agent is coupled to the public hub.

34. A system of facilitating the exchange of commodities, said system comprising:
means for utilizing a public hub in the exchange of one or more commodities, wherein a plurality of entities is associated with the exchange; and
means for performing one or more selected functions of the exchange via an automated trusted agent.

35. The system of claim 34, wherein the one or more selected functions of the exchange include managing one or more pricing terms associated with the exchange.

36. The system of claim 35, wherein the managing of one or more pricing terms includes masking at least one pricing term of the one or more pricing terms to shield the at least one pricing term from one or more entities of the plurality of entities.

37. The system of claim 36, wherein the one or more entities include one or more contract manufacturers.

38. The system of claim 36, wherein the one or more entities include one or more suppliers.

39. The system of claim 34, wherein the one or more selected functions of the exchange include managing one or more contract terms associated with the exchange.

40. The system of claim 34, wherein the means for performing enables protection of one or more contract terms associated with the exchange from one or more entities of the plurality of entities.

41. The system of claim 40, wherein the protection includes shielding price from one or more entities of the plurality of entities.

42. The system of claim 34, wherein at least one entity of said plurality of entities includes at least one contract manufacturer, and wherein the means for performing enables controlling allocation of commodities across the at least one contract manufacturer.

43. The system of claim 34, wherein multiple entities of said plurality of entities include multiple suppliers, and wherein the means for performing enables dividing an order for a plurality of commodities of the exchange among the multiple suppliers.

44. The system of claim 34, wherein the means for performing enables the managing of supply and demand of commodities.

45. The system of claim 34, wherein the automated trusted agent includes one or more tools utilized in performing the one or more selected functions.

46. The system of claim 45, wherein the one or more tools include at least one of a purchase order/supply order engine, linked pricing tables, and one or more supply/demand aggregation tools.

47. The system of claim 34, wherein the automated trusted agent is coupled to the public hub.

48. The system of claim 34, wherein the automated trusted agent is a part of the public hub.

49. The system of claim 34, wherein the exchange is based on a buy/sell model.

50. The system of claim 34, wherein one entity of the plurality of entities is an Original Equipment Manufacturer (OEM), and wherein said means for utilizing the public hub comprises means for utilizing the public hub by the OEM to obtain a product having at least a portion of the one or more commodities.

51. The system of claim 50, wherein the automated trusted agent enables the OEM to retain control of one or more facets of the exchange.

52. The system of claim 51, wherein the automated trusted agent enables the OEM to retain control of at least one of sensitive information, one or more business processes, and one or more relationships associated with the exchange.

53. The system of claim 34, wherein said means for utilizing the public hub comprises means for utilizing the public hub in a networked environment.

54. The system of claim 34, wherein the plurality of entities comprises one or more contract manufacturers and one or more suppliers.

55. The system of claim 54, wherein the means for performing one or more selected functions of the exchange via the automated trusted agent comprises:
means for placing an order for the one or more commodities with at least one supplier of the one or more suppliers, the order representing a request from at least one contract manufacturer of the one or more contract manufacturers;
means for handling one or more invoices received from the at least one supplier; and
means for invoicing the at least one contract manufacturer requesting the one or more commodities.

56. The system of claim 55, wherein the plurality of entities further comprises an Original Equipment Manufacturer (OEM) requesting one or more products from the one or more contract manufacturers, and wherein the means for performing further comprises means for forwarding to the OEM a price differential, if any, resulting from a difference in the one or more invoices received from the at least one supplier and the invoicing of the at least one contract manufacturer.

57. A system of facilitating the exchange of commodities, said system comprising:
a first entity to obtain one or more commodities of a product, said one or more commodities to be obtained from one or more second entities via a public hub; and
an automated trusted agent to interface between said first entity and said one or more second entities, wherein one or more aspects associated with obtaining said one or more commodities are controlled by said automated trusted agent.

58. The system of claim 57, wherein the one or more aspects include means for invoicing associated with the one or more commodities.

59. The system of claim 57, wherein the first entity is a contract manufacturer and the one or more second entities are one or more suppliers.

60. The system of claim 57, further comprising a third entity to place an order for the product at said first entity.

61. The system of claim 60, wherein said third entity is an Original Equipment Manufacturer (OEM), and wherein the automated trusted agent protects for the OEM one or more facets associated with the order.

62. The system of claim 61, wherein the one or more facets include one or more contract terms.

63. The system of claim 62, wherein the one or more contract terms include one or more price terms.

64. The system of claim 61, wherein the one or more facets include at least one of sensitive information, one or more business processes, and one or more relationships associated with obtaining the one or more commodities.

65. The system of claim 57, wherein the automated trusted agent is a part of the public hub.

66. The system of claim 57, wherein the automated trusted agent is coupled to the public hub.

67. A system of facilitating the exchange of commodities, said system comprising:
a public hub used in the exchange of one or more commodities, wherein a plurality of entities is associated with the exchange; and
an automated trusted agent to perform one or more selected functions of the exchange.

68. A system of facilitating the exchange of commodities, said system comprising:
means for requesting by a first entity to obtain one or more commodities of a product, said one or more commodities to be obtained from one or more second entities via a public hub; and
means for using an automated trusted agent to interface between said first entity and said one or more second entities, wherein one or more aspects associated with obtaining said one or more commodities are controlled by said automated trusted agent.

69. At least one program storage device readable by a machine, tangibly embodying at least one program of instructions executable by the machine to perform a method of facilitating the exchange of commodities, said method comprising:
utilizing a public hub in the exchange of one or more commodities, wherein a plurality of entities is associated with the exchange; and
performing one or more selected functions of the exchange via an automated trusted agent.

70. The at least one program storage device of claim 69, wherein the one or more selected functions of the exchange include managing one or more pricing terms associated with the exchange.

71. The at least one program storage device of claim 70, wherein the managing of one or more pricing terms includes masking at least one pricing term of the one or more pricing terms to shield the at least one pricing term from one or more entities of the plurality of entities.

72. The at least one program storage device of claim 71, wherein the one or more entities include one or more contract manufacturers.

73. The at least one program storage device of claim 71, wherein the one or more entities include one or more suppliers.

74. The at least one program storage device of claim 69, wherein the one or more selected functions of the exchange include managing one or more contract terms associated with the exchange.

75. The at least one program storage device of claim 69, wherein the performing enables protection of one or more contract terms associated with the exchange from one or more entities of the plurality of entities.

76. The at least one program storage device of claim 75, wherein the protection includes shielding price from one or more entities of the plurality of entities.

77. The at least one program storage device of claim 69, wherein at least one entity of said plurality of entities includes at least one contract manufacturer, and wherein the performing enables controlling allocation of commodities across the at least one contract manufacturer.

78. The at least one program storage device of claim 69, wherein multiple entities of said plurality of entities include multiple suppliers, and wherein the performing enables dividing an order for a plurality of commodities of t he exchange among the multiple suppliers.

79. The at least one program storage device of claim 69, wherein the performing enables the managing of supply and demand of commodities.

80. The at least one program storage device of claim 69, wherein the automated trusted agent includes one or more tools utilized in performing the one or more selected functions.

81. The at least one program storage device of claim 80, wherein the one or more tools include at least one of a purchase order/supply order engine, linked pricing tables, and one or more supply/demand aggregation tools.

82. The at least one program storage device of claim 69, wherein the automated trusted agent is coupled to the public hub.

83. The at least one program storage device of claim 69, wherein the automated trusted agent is a part of the public hub.

84. The at least one program storage device of claim 69, wherein the exchange is based on a buy/sell model.

85. The at least one program storage device of claim 69, wherein one entity of the plurality of entities is an Original Equipment Manufacturer (OEM), and wherein said utilizing the public hub comprises utilizing the public hub by the OEM to obtain a product having at least a portion of the one or more commodities.

86. The at least one program storage device of claim 85, wherein the automated trusted agent enables the OEM to retain control of one or more facets of the exchange.

87. The at least one program storage device of claim 86, wherein the automated trusted agent enables the OEM to retain control of at least one of sensitive information, one or more business processes, and one or more relationships associated with the exchange.

88. The at least one program storage device of claim 69, wherein said utilizing the public hub comprises utilizing the public hub in a networked environment.

89. The at least one program storage device of claim 69, wherein the plurality of entities comprises one or more contract manufacturers and one or more suppliers.

90. The at least one program storage device of claim 89, wherein the performing one or more selected functions of the exchange via the automated trusted agent comprises:
placing an order for the one or more commodities with at least one supplier of the one or more suppliers, the order representing a request from at least one contract manufacturer of the one or more contract manufacturers;
handling one or more invoices received from the at least one supplier; and
invoicing the at least one contract manufacturer requesting the one or more commodities.

91. The at least one program storage device of claim 90, wherein the plurality of entities further comprises an Original Equipment Manufacturer (OEM) requesting one or more products from the one or more contract manufacturers, and wherein the performing further comprises forwarding to the OEM a price differential, if any, resulting from a difference in the one or more invoices received from the at least one supplier and the invoicing of the at least one contract manufacturer.

92. At least one program storage device readable by a machine, tangibly embodying at least one program of instructions executable by the machine to perform a method of facilitating the exchange of commodities, said method comprising:
requesting by a first entity to obtain one or more commodities of a product, said one or more commodities to be obtained from one or more second entities via a public hub; and
using an automated trusted agent to interface between said first entity and said one or more second entities, wherein one or more aspects associated with obtaining said one or more commodities are controlled by said automated trusted agent.

93. The at least one program storage device of claim 92, wherein the one or more aspects include invoicing associated with the one or more commodities.

94. The at least one program storage device of claim 92, wherein the first entity is a contract manufacturer and the one or more second entities are one or more suppliers.

95. The at least one program storage device of claim 92, wherein said method further comprises placing an order for the product at said first entity, by a third entity.

96. The at least one program storage device of claim 95, wherein said third entity is an Original Equipment Manufacturer (OEM), and wherein the automated trusted agent protects for the OEM one or more facets associated with the order.

97. The at least one program storage device of claim 96, wherein the one or more facets include one or more contract terms.

98. The at least one program storage device of claim 97, wherein the one or more contract terms include one or more price terms.

99. The at least one program storage device of claim 96, wherein the one or more facets include at least one of sensitive information, one or more business processes, and one or more relationships associated with obtaining the one or more commodities.

100. The at least one program storage device of claim 92, wherein the automated trusted agent is a part of the public hub.

101. The at least one program storage device of claim 92, wherein the automated trusted agent is coupled to the public hub.
